(19) United States
(12) Patent Application Publication
(10) Pub. No.: US 2025/0162879 A1
(43) Pub. Date: May 22, 2025

(54) SELECTIVE ACETYLENE OXIDATION IN GAS MIXTURES

(71) Applicant: Regents of the University of Minnesota, Minneapolis, MN (US)

(72) Inventors: Matthew Mickel Jacob, Minneapolis, MN (US); Aditya Bhan, Minneapolis, MN (US)

(73) Assignee: Regents of the University of Minnesota, Minneapolis, MN (US)

(21) Appl. No.: 18/743,688

(22) Filed: Jun. 14, 2024

Related U.S. Application Data
(60) Provisional application No. 63/521,542, filed on Jun. 16, 2023.

(51) Int. Cl. C01B 32/50

(52) U.S. Cl. CPC C01B 32/50

(57) ABSTRACT

A feed stream is contacted with a metal oxide catalyst disposed within a reactor. The feed stream includes a mixture of gases. The mixture of gases includes acetylene. The metal oxide catalyst includes a metal oxide. In response to contacting the feed stream with the metal oxide catalyst, the acetylene of the feed stream is selectively oxidized to produce at least one of carbon monoxide or carbon dioxide. A product stream is discharged from the reactor. The product stream includes the at least one of the carbon monoxide or the carbon dioxide produced.

### CROSS REFERENCE TO RELATED APPLICATIONS

This application claims the benefit of U.S. Provisional Application Ser. No. 63/521,542, filed on Jun. 16, 2023, the entire contents of which are incorporated herein by reference in their entirety.

### STATEMENT REGARDING FEDERALLY SPONSORED RESEARCH OR DEVELOPMENT

This invention was made with government support under DE-SC0019028 awarded by the U.S. Department of Energy. The government has certain rights in the invention.

### TECHNICAL FIELD

This disclosure relates to selective oxidation of compounds in gas mixtures.

### BACKGROUND

Ethylene is a key feedstock in chemical industry and often includes traces of acetylene contaminants. Acetylene impurities in ethylene can contaminate and/or deactivate catalysts that are typically used in ethylene processing. Therefore, it is useful (and oftentimes necessary) to separate acetylene from ethylene. Ethylene and acetylene are hydrocarbon molecules with similar sizes and boiling points, and separation of the two can be difficult. An example of a conventional method for separating ethylene and acetylene is distillation. Distillation for separating ethylene and acetylene, however, can be very energy intensive.

### SUMMARY

This disclosure describes technologies relating to selective oxidation of acetylene in gas mixtures. The subject matter described in this disclosure can have particular implementations, so as to realize one or more of the following advantages. The methods and systems described herein can be implemented to selectively oxidize acetylene in gas mixtures, and in particular, hydrocarbon mixtures (such as gas mixtures that include both acetylene and ethylene), with or without the presence of an oxidant in the gas phase. For example, the methods and systems described herein can be implemented to selectively oxidize acetylene in gas mixtures that can include various other components, such as water (steam), carbon monoxide, carbon dioxide, and hydrocarbons (such as hydrocarbons having a carbon number ranging from 1 to 6). The methods and systems described herein can be implemented to reduce a concentration of acetylene in a gas mixture to less than 10 parts per million (ppm) (and in some cases, less than 5 ppm, less than 4 ppm, less than 3 ppm, less than 2 ppm, or less than 1 ppm) by volume independent of distillation. The methods and systems described herein can be significantly less energy-intensive and less capital-intensive in comparison to conventional methods, such as distillation or acetylene semi-hydrogenation. The methods and systems described herein can be implemented flexibly over a variety of operation modes, which advantageously allows for batch processing and continuous processing in flow reactors operating at steady state in the presence of an oxidant, such as air or oxygen, in the gas phase. The methods and systems described herein implement reduction-oxidation reactions, which allow for the catalysts to be beneficially regenerated and reused. The oxygen content of the catalysts described herein can be easily replenished by passing an oxygen-containing stream (such as air, which is readily available) over the catalysts, so that the catalysts can be regenerated and reused. The methods and systems described herein can selectively oxidize acetylene, which can obviate separation methods to remove easily deprotonated molecules (such as alkynes) from multi-component hydrocarbon mixtures prior to the oxidation process, thereby allowing for more cost-effective and more efficient selective removal of acetylene in comparison to conventional methods and systems. The described catalysts are robust to repeated cycling between acetylene oxidation and catalyst regeneration and can exhibit consistently high selectivity to acetylene oxidation. Further, the described catalysts do not require elevated pressures for selective oxidation of acetylene and are also tolerant to exposure to carbon dioxide.

Certain aspects of the subject matter described can be implemented as a method. A feed stream is contacted with a metal oxide catalyst disposed within a reactor. The feed stream includes a mixture of gases. The mixture of gases includes acetylene. The metal oxide catalyst includes a metal oxide. In response to contacting the feed stream with the metal oxide catalyst, the acetylene of the feed stream is selectively oxidized to produce at least one of carbon monoxide or carbon dioxide. A product stream is discharged from the reactor. The product stream includes the at least one of the carbon monoxide or the carbon dioxide produced.

This, and other aspects, can include one or more of the following features. The metal oxide can include at least one of bismuth (Bi), indium (In), antimony (Sb), tellurium (Te), chromium (Cr), lanthanum (La), lead (Pb), tin (Sn), molybdenum (Mo), platinum (Pt), rhodium (Rh), cobalt (Co), manganese (Mn), zinc (Zn), silver (Ag), palladium (Pd), copper (Cu), hafnium (Hf), niobium (Nb), cerium (Ce), or iron (Fe). The metal oxide catalyst can be disposed on a support. The support can include at least one of silicon oxide, aluminum oxide, titanium oxide, niobium oxide, or zirconium oxide. The metal oxide catalyst can include a promoter. The promoter can include at least one of lithium (Li), potassium (K), cesium (Cs), magnesium (Mg), strontium (Sr), barium (Ba), chromium (Cr), molybdenum (Mo), tungsten (W), nickel (Ni), palladium (Pd), platinum (Pt), copper (Cu), silver (Ag), gold (Au), zinc (Zn), cadmium (Cd), mercury (Hg), gallium (Ga), indium (In), thallium (Tl), tin (Sn), lead (Pb), arsenic (As), antimony (Sb), bismuth (Bi), lanthanum (La), cerium (Ce), samarium (Sm), europium (Eu), or dysprosium (Dy). The method can include increasing at least one of reactivity, selectivity to acetylene oxidation, or structural stability of the metal oxide catalyst, by the promoter, in response to loss of oxygen by the metal oxide catalyst. The metal oxide catalyst can include about 0.01 weight percent (wt. %) to about 20 wt. % of the promoter. The product stream discharged from the reactor can have an acetylene content less than about 10 parts per million (ppm). The feed stream can be contacted with the metal oxide catalyst within the reactor at an operating temperature in a range of from about 573 Kelvin (K) to about 923 K. The feed stream can be contacted with the metal oxide catalyst within the reactor at an operating pressure in a range of from about 10 kilopascals (kPa) to about 5,000 kPa. An oxygen replenishing stream including oxygen can be flowed to the reactor after discharging the product stream. The oxygen of the oxygen replenishing stream can increase a number of metal-oxygen bonds in the metal oxide catalyst, thereby regenerating the metal oxide catalyst. The oxygen replenishing stream can be flowed to a second reactor within which a second metal oxide catalyst is disposed. The second metal oxide catalyst can include a second metal oxide. The oxygen of the oxygen replenishing stream can increase a number of metal-oxygen bonds in the second metal oxide catalyst. The oxygen replenishing stream can be flowed to the second reactor while the feed stream is contacted with the metal oxide catalyst within the reactor. The feed stream can be contacted with the second metal oxide catalyst within the second reactor. The oxygen replenishing stream can be flowed to the reactor while the feed stream is contacted with the second metal oxide catalyst within the second reactor. In response to contacting the feed stream with the second metal oxide catalyst, the acetylene of the feed stream can be selectively oxidized to produce at least one of carbon monoxide or carbon dioxide. A second product stream can be discharged from the second reactor. The second product stream can include the at least one of the carbon monoxide or the carbon dioxide produced within the second reactor. The second metal oxide catalyst can have the same composition as the metal oxide catalyst. The metal oxide catalyst can be transported from the reactor to a regenerator. An oxygen replenishing stream including oxygen can be flowed to the regenerator. The oxygen of the oxygen replenishing stream can increase a number of metal-oxygen bonds in the metal oxide catalyst, thereby regenerating the metal oxide catalyst. The regenerated metal oxide catalyst can be transported from the regenerator to the reactor. The mixture of gases can include a hydrocarbon different from acetylene.

Certain aspects of the subject matter described can be implemented as a system. The system includes a reactor and a metal oxide catalyst. The reactor is configured to receive a feed stream. The feed stream includes a mixture of gases. The mixture of gases includes acetylene. The metal oxide catalyst is disposed within the reactor. The metal oxide catalyst includes a metal oxide. The metal oxide catalyst is configured to, in response to contact with the feed stream within the reactor, selectively oxidize the acetylene of the feed stream to produce at least one of carbon monoxide or carbon dioxide. The reactor is configured to discharge a product stream. The product stream includes the at least one of the carbon monoxide or the carbon dioxide produced.

This, and other aspects, can include one or more of the following features. The metal oxide can include at least one of bismuth (Bi), indium (In), antimony (Sb), tellurium (Te), chromium (Cr), lanthanum (La), lead (Pb), tin (Sn), molybdenum (Mo), platinum (Pt), rhodium (Rh), cobalt (Co), manganese (Mn), zinc (Zn), silver (Ag), palladium (Pd), copper (Cu), hafnium (Hf), niobium (Nb), cerium (Ce), or iron (Fe). The metal oxide catalyst can be disposed on a support. The support can include at least one of silicon oxide, aluminum oxide, titanium oxide, niobium oxide, or zirconium oxide. The metal oxide catalyst can include a promoter. The promoter can include at least one of lithium (Li), potassium (K), cesium (Cs), magnesium (Mg), strontium (Sr), barium (Ba), chromium (Cr), molybdenum (Mo), tungsten (W), nickel (Ni), palladium (Pd), platinum (Pt), copper (Cu), silver (Ag), gold (Au), zinc (Zn), cadmium (Cd), mercury (Hg), gallium (Ga), indium (In), thallium (Tl), tin (Sn), lead (Pb), arsenic (As), antimony (Sb), bismuth (Bi), lanthanum (La), cerium (Ce), samarium (Sm), europium (Eu), or dysprosium (Dy). The promoter can be configured to increase at least one of reactivity, selectivity to acetylene oxidation, or structural stability of the metal oxide catalyst, by the promoter, in response to loss of oxygen by the metal oxide catalyst. The metal oxide catalyst can include about 0.01 weight percent (wt. %) to about 20 wt. % of the promoter. The product stream can have an acetylene content less than about 10 parts per million (ppm). The reactor can be configured to operate at an operating temperature in a range of from about 573 Kelvin (K) to about 923 K. The reactor can be configured to operate at an operating pressure in a range of from about 10 kilopascals (kPa) to about 5,000 kPa. The reactor can be configured to receive an oxygen replenishing stream after discharging the product stream. The oxygen replenishing stream can include oxygen. The oxygen of the oxygen replenishing stream can increase a number of metal-oxygen bonds in the metal oxide catalyst, thereby regenerating the metal oxide catalyst. The system can include a second reactor. The system can include a second metal oxide catalyst. The second metal oxide catalyst can be disposed within the second reactor. The second metal oxide catalyst can include a second metal oxide. The second metal oxide catalyst can have the same composition as the metal oxide catalyst. The system can include a flow control system. The flow control system can include a feed inlet flowline that splits and connects separately to the reactor and the second reactor. The feed inlet flowline can be configured to flow the feed stream to one of the reactor or the second reactor at any given time. The flow control system can include an oxygen inlet flowline that splits and connects separately to the reactor and the second reactor. The oxygen inlet flowline can be configured to flow the oxygen replenishing stream to a different one of the reactor of the second reactor as the feed inlet flowline. The system can include a regenerator. The regenerator can be configured to receive an oxygen replenishing stream including oxygen. The regenerator can be connected to the reactor by a spent catalyst flowline. The spent catalyst flowline can be configured to transport the metal oxide catalyst from the reactor to the regenerator. The oxygen of the oxygen replenishing stream can increase a number of metal-oxygen bonds in the metal oxide catalyst within the regenerator, thereby regenerating the metal oxide catalyst. The system can include a regenerated catalyst flowline. The regenerated catalyst flowline can be configured to transport the regenerated metal oxide catalyst from the regenerator to the reactor. The mixture of gases can include a hydrocarbon different from acetylene.

The details of one or more implementations of the subject matter of this disclosure are set forth in the accompanying drawings and the description. Other features, aspects, and advantages of the subject matter will become apparent from the description, the drawings, and the claims.

### DESCRIPTION OF DRAWINGS

FIG. 1A is a schematic diagram of an example system for a batch process of selective oxidation of acetylene in gas mixtures.

FIG. 1B is a schematic diagram of an example system for a batch process of selective oxidation of acetylene in gas mixtures.

FIG. 2A is a schematic diagram of an example system for a continuous process of selective oxidation of acetylene in gas mixtures.

FIG. 2B is a schematic diagram of an example system for a continuous process of selective oxidation of acetylene in gas mixtures.

FIG. 3 is a flow chart of an example method for selective oxidation of acetylene in gas mixtures.

FIG. 4 includes multiple graphs showing experimental data for selective oxidation of acetylene in gas mixtures.

FIG. 5 is a graph showing experimental data for selective oxidation of acetylene in a gas mixture including ethylene along with an oxygen co-feed.

FIG. 6 includes multiple graphs showing experimental data for selective oxidation of acetylene in gas mixtures in successive reduction and oxidation cycles.

### DETAILED DESCRIPTION

This disclosure describes selective oxidation of acetylene in gas mixtures. The acetylene in the gas mixture is oxidized in response to contact with a metal oxide catalyst disposed within a reactor. The metal oxide catalyst includes a metal oxide that has one or more metal-oxygen bonds (e.g., one, two, three, four, or more metal-oxygen bonds) that are available for reduction-oxidation reactions. Acetylene oxidation produces carbon monoxide, carbon dioxide, water, or combinations of these. Acetylene oxidation is paired with the reduction of the metal oxide. Over time, the oxygen content of the metal oxide catalyst reduces to a level at which regeneration of the metal oxide catalyst is desirable. Regenerating the metal oxide catalyst involves flowing an oxygen-containing gas (such as air) over the metal oxide catalyst. The oxygen from the oxygen-containing gas re-oxidizes the metal oxide catalyst and replenishes the oxygen content of the metal oxide catalyst, thereby regenerating the metal oxide catalyst. Once the metal oxide catalyst has been regenerated, the metal oxide catalyst can be re-used to selectively oxidize acetylene.

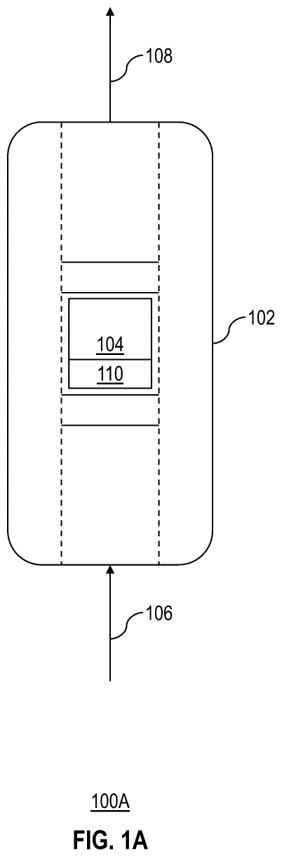

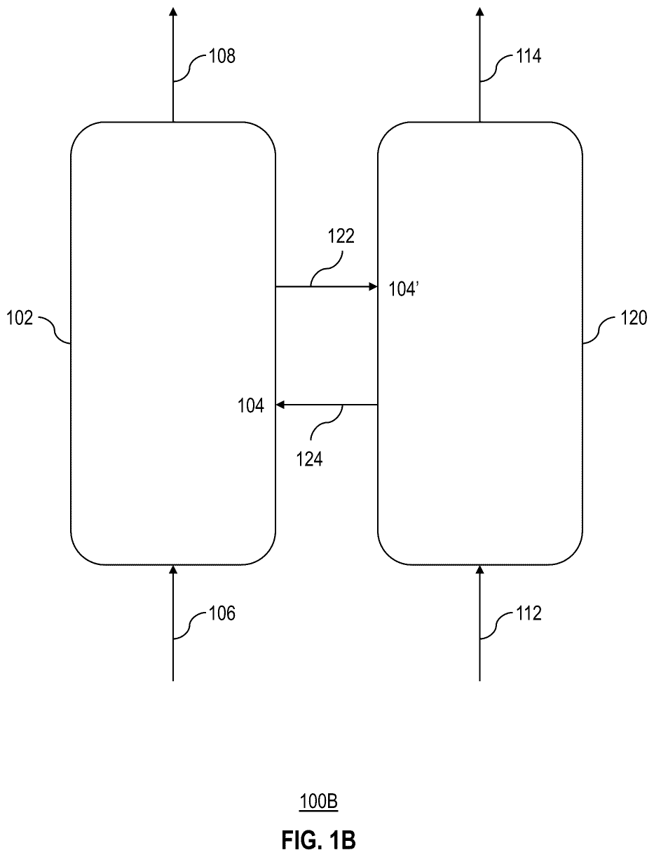

FIG. 1A depicts a schematic diagram of an example system 100A for selective oxidation of acetylene in gas mixtures. The system 100A includes a reactor 102 and a metal oxide catalyst 104. The reactor 102 can be, for example, a pressure vessel that houses the metal oxide catalyst 104. The metal oxide catalyst 104 can be disposed within the reactor 102, for example, in the form of a packed catalyst bed. The reactor 102 is configured to receive a feed stream 106. The feed stream 106 includes a mixture of gases, which includes acetylene. In some implementations, the mixture of gases also includes a hydrocarbon different from acetylene, such as ethylene. In some implementations, the mixture of gases includes water (steam), carbon monoxide, carbon dioxide, hydrogen, saturated hydrocarbons having a carbon number from 1 to 6, monounsaturated hydrocarbons having a carbon number from 1 to 6 (such as ethylene, which is a monounsaturated hydrocarbon with a carbon number of 2), cyclic hydrocarbons having a carbon number from 6 to 8 (including those among these that are aromatic), trace quantities (<0.1 mol. %) of other cyclic or acyclic organic compounds, or any combinations of these. In some implementations, the feed stream 106 includes from about 0.001 mol. % to about 50 mol. % of acetylene. The metal oxide catalyst 104 is disposed within the reactor 102. The metal oxide catalyst 104 includes a metal oxide that has metal-oxygen bonds. The oxygen present in the metal-oxygen bonds of the metal oxide catalyst 104 are available for participating in reduction-oxidation (redox) reactions with the feed stream 106 in the reactor 102. For example, lattice oxygen present in the metal oxide catalyst 104 can provide an alternative pathway for reacting with acetylene (for example, by combustion), thereby reducing the acetylene concentration. One drawback of conventional hydrocarbon combustion at high temperatures (such as greater than 1000 Kelvin (K)) with oxygen cofeed is that such processes are radical-mediated processes which result in the indiscriminate activation of hydrocarbon species by radicals and limited selectivity to combustion of a particular hydrocarbon (such as acetylene) in a hydrocarbon mixture. In contrast, the metal oxide catalyst 104 selectively activates the carbon-hydrogen (C—H) bonds of acetylene, which initiates a reaction cascade which results in combustion. The combustion of acetylene via the oxygen preset in the metal oxide catalyst 104 can, in some cases, have a first-order rate constant that is several orders of magnitudes greater than (for example, 3000×) the rate constant for conventional acetylene combustion with oxygen in the gas phase. By employing the metal oxide catalyst 104 having active sites for C—H activation that retain high selectivity to C—H activation of acetylene at a high degree of oxide reduction, lattice oxygen present in the metal oxide catalyst 104 can be discharged stoichiometrically to combust acetylene in mixtures that include acetylene (such as the feed stream 106) during reduction half cycles and replenished with oxygen (for example, by an oxygen replenishing stream 112) during oxidation half cycles.

The metal oxide catalyst 104 is configured to, in response to contact with the feed stream 106 within the reactor 102, selectively oxidize the acetylene of the feed stream 106. The metal oxide catalyst 104 accelerates the rate of oxidation of acetylene more in comparison to the other compound(s) (such as ethylene and/or other hydrocarbons) present in the feed stream 106 and therefore selectively oxidizes the acetylene in the feed stream 106 in favor over the remaining compound(s) in the feed stream 106. The reactor 102 can, for example, be equipped with and/or coupled to a heater or a furnace that supplies heat to the reactor 102, so that a desired operating temperature is maintained within the reactor 102. The operating temperature within the reactor 102 can be adjusted to improve selective oxidation of acetylene in the reactor 102. In some implementations, the reactor 102 is configured to operate at an acetylene oxidation operating temperature in a range of from about 573 Kelvin (K) to about 923 K, from about 600 K to about 900 K, or from about 700 K to about 800 K. In some implementations, the reactor 102 is configured to operate at an acetylene oxidation operating pressure in a range of from about 10 kilopascals (kPa) to about 5,000 kPa, from about 10 kPa to about 500 kPa, or from about 50 kPa to about 150 kPa.

Oxidation of acetylene in the reactor 102 produces carbon monoxide, carbon dioxide, or both. The oxidation of acetylene in the reactor 102 is coupled with the reduction of the metal oxide of the metal oxide catalyst 104 (which is the reason the reaction is considered a redox reaction), which results in the co-production of water in the form of steam. The reactor 102 is configured to discharge a product stream 108. The product stream 108 includes the carbon monoxide and/or the carbon dioxide that is produced in the reactor 102. The product stream 108 can also include the remaining portion of the feed stream 106 that did not react within the reactor 102. For example, the product stream 108 exiting the reactor 102 can also include the remaining compounds that were present in the feed stream 106 entering the reactor 102, such as ethylene, that were not oxidized within the reactor 102. In some implementations, the reactor 102 and the metal oxide catalyst 104 are cooperatively configured to oxidize at least 99%, at least 99.9%, or at least 99.99% of the acetylene present in the feed stream 106 into carbon monoxide, carbon dioxide, or both under acetylene oxidation conditions. In some implementations, the product stream 108 exiting the reactor 102 has an acetylene content that is less than about 10 parts per million (ppm) by volume.

The metal oxide of the metal oxide catalyst 104 includes at least one element that can exist in multiple oxidation states. For example, the metal oxide of the metal oxide catalyst 104 includes at least one metal that may exhibit lone pair characteristics in the prevalent oxidation state during reaction conditions. In some implementations, the metal oxide of the metal oxide catalyst 104 includes at least one of bismuth (Bi), indium (In), antimony (Sb), tellurium (Te), chromium (Cr), lanthanum (La), lead (Pb), tin (Sn), molybdenum (Mo), platinum (Pt), rhodium (Rh), cobalt (Co), manganese (Mn), zinc (Zn), silver (Ag), palladium (Pd), copper (Cu), hafnium (Hf), niobium (Nb), cerium (Ce), or iron (Fe). For example, the metal oxide of the metal oxide catalyst 104 can include bismuth oxide (Bi₂O₃), indium(III) oxide (In₂O₃), diantimony tetroxide (Sb₂O₄), antimony trioxide (Sb₂O₃), antimony pentoxide (Sb₂O₅), tellurium monoxide (TeO), tellurium dioxide (TeO₂), tellurium trioxide (TeO₃), chromium(II) oxide (CrO), chromium(III) oxide (Cr₂O₃), chromium dioxide (CrO₂), chromium trioxide (CrO₃), lanthanum(III) oxide (La₂O₃), lead(II) oxide (PbO), lead(II,IV) oxide (Pb₃O₄), lead dioxide (PbO₂), tin(II) oxide (SnO), tin(IV) oxide (SnO₂), molybdenum(IV) oxide (MoO₂), molybdenum(VI) oxide (MoO₃), platinum oxide (PtO), rhodium(III) oxide (Rh₂O₃), cobalt(II,III) oxide (Co₃O₄), manganese(III) oxide (Mn₂O₃), zinc oxide (ZnO), silver oxide (Ag₂O), palladium oxide (PdO), copper(I) oxide (Cu₂O), hafnium(IV) oxide (HfO₂), niobium pentoxide (Nb₂O₅), iron(III) oxide (Fe₂O₃), bismuth molybdenum oxide (Bi₂Mo₃O₁₂, Bi₂Mo₂O₉, or Bi₂MoO₆), indium molybdenum oxide (In₂Mo₃O₁₂), cerium molybdenum oxide (Ce₂Mo₃O₁₂), aluminum molybdenum oxide (Al₂Mo₃O₁₂), chromium molybdenum oxide (Cr₂Mo₃O₁₂), iron molybdenum oxide (Fe₂Mo₃O₁₂) or any combinations of these. The metal oxide catalyst 104 can selectively oxidize the acetylene present in the feed stream 106 even in cases where oxygen is not additionally present in the feed stream 106. That is, the oxygen content in the metal oxide catalyst 104 itself can contribute to the redox reactions involved in the selective oxidation of acetylene. In some implementations, the feed stream 106 can also include oxygen, and the oxygen present in the feed stream 106 can additionally or alternatively participate in the redox reactions involved in the selective oxidation of acetylene.

In some implementations, the metal oxide catalyst 104 is disposed on a support 110. The support 110 can include, for example, at least one of silicon oxide (SiO₂), aluminum oxide (Al₂O₃), titanium oxide (TiO₂), niobium oxide (Nb₂O₅), or zirconium oxide (ZrO₂). In some implementations, the metal oxide catalyst 104 includes a promoter that is configured to increase at least one of reactivity, selectivity to acetylene oxidation, or structural stability of the metal oxide catalyst 104 in response to loss of oxygen by the metal oxide catalyst 104 within the reactor 102. The promoter can simply be one or more elements incorporated into the chemical and physical structure of the metal oxide catalyst 104. In some implementations, the promoter includes at least one of lithium (Li), potassium (K), cesium (Cs), magnesium (Mg), strontium (Sr), barium (Ba), chromium (Cr), molybdenum (Mo), tungsten (W), nickel (Ni), palladium (Pd), platinum (Pt), copper (Cu), silver (Ag), gold (Au), zinc (Zn), cadmium (Cd), mercury (Hg), gallium (Ga), indium (In), thallium (Tl), tin (Sn), lead (Pb), arsenic (As), antimony (Sb), bismuth (Bi), lanthanum (La), cerium (Ce), samarium (Sm), europium (Eu), or dysprosium (Dy). In some implementations, the metal oxide catalyst 104 includes about 0.01 weight percent (wt. %) to about 20 wt. % of the promoter.

In some implementations, after selectively oxidizing the acetylene in the feed stream 106 and discharging the product stream 108, the reactor 102 is switched to a catalyst regeneration mode. In the catalyst regeneration mode, the reactor 102 is configured to receive an oxygen replenishing stream 112. The oxygen replenishing stream 112 includes an oxidant, such as oxygen gas (O₂) and/or an oxygen-containing compound (for example, nitrous oxide (N₂O)). As one example, the oxygen replenishing stream 112 includes air, which includes oxygen. The oxygen of the oxygen replenishing stream 112 replenishes the oxygen content in the metal oxide catalyst 104 and re-establishes the metal-oxygen bonds in the metal oxide catalyst 104, thereby regenerating the metal oxide catalyst 104. Once the metal oxide catalyst 104 is regenerated, the reactor 102 can be switched back to the selective acetylene oxidation mode for receiving new feed (for example, the feed stream 106) and selectively oxidizing the acetylene in the new feed into carbon monoxide, carbon dioxide, or both. The system 100A can, for example, be operated as a batch process, which can include switching back and forth between selective acetylene oxidation mode and catalyst regeneration mode. Separation between selective oxidation mode and catalyst regeneration mode can avoid flammability concerns associated with high temperature combustion and can avoid the potential of forming unselective oxygen species upon the conversion of oxygen. Further, the metal oxide catalyst 104 is robust and can withstand cycling between selective acetylene oxidation mode and catalyst regeneration mode and retain high selectivity to acetylene oxidation. For example, although cycling between selective acetylene oxidation mode and catalyst regeneration mode may significantly change the surface morphology of the metal oxide catalyst 104, formation of metal and/or metal oxide phases with lower selectivity to acetylene oxidation can still be avoided. Significant changes in the surface morphology of the metal oxide catalyst after redox cycling can be attributed to recrystallization of the oxygen-deficient reduced state upon exposure to oxygen gas for regenerating crystal structures for metal oxide surfaces, which expose a larger area for stoichiometric acetylene combustion reactions to occur.

FIG. 1B depicts a schematic diagram of an example system 100B for selective oxidation of acetylene in gas mixtures. The system 100B is substantially similar to the system 100A shown in FIG. 1A. For example, the system 100B can include the same components as the system 100A. The system 100B includes the reactor 102 and the metal oxide catalyst 104. In some implementations, as shown in FIG. 1B, the system 100B omits the support 110. Although not shown in FIG. 1B, the system 100B can optionally include the support 110, and in such implementations, the metal oxide catalyst 104 can be disposed on the support within the reactor 102 (similar as shown with respect to system 100A of FIG. 1A). The system 100B also includes a regenerator 120. As the metal oxide catalyst 104 selectively oxidizes acetylene in the feed stream 106, the metal oxide catalyst 104 loses a portion of its oxygen content, and the number of metal-oxygen bonds in the metal oxide catalyst 104 decreases. Eventually, the metal oxide catalyst 104 becomes a spent metal oxide catalyst 104′, at which point the oxygen content of the spent metal oxide catalyst 104′ should be replenished in order to re-establish the metal-oxygen bonds for continuing the selective oxidation of acetylene. Spent metal oxide catalyst 104′ can be regenerated within the regenerator 120 to produce a regenerated metal oxide catalyst 104. The regenerated metal oxide catalyst 104 can be re-used, for example, within the reactor 102 to continue to selectively oxidize acetylene in the feed stream 106. The oxygen replenishing stream 112 flows into the regenerator 120, where the oxygen of the oxygen replenishing stream 112 replenishes the oxygen content in the spent metal oxide catalyst 104′ and re-establishes the metal-oxygen bonds in the spent metal oxide catalyst 104′, thereby regenerating the metal oxide catalyst 104. The regenerator 120 discharges an exhaust stream 114, which includes a remaining portion of the oxygen replenishing stream 112. The exhaust stream 114 exiting the regenerator 120 has a reduced oxygen content and/or oxygen flow rate in comparison to the oxygen replenishing stream 112 entering the regenerator 120.

The system 100B can include a spent catalyst flowline 122 and a regenerated catalyst flowline 124. The spent catalyst flowline 122 can be connected to the reactor 102 and the regenerator 120 for transporting spent metal oxide catalyst 104′ from the reactor 102 to the regenerator 120, so that the spent metal oxide catalyst 104′ can be regenerated in the regenerator 120. The regenerated catalyst flowline 124 can be connected to the regenerator 120 and the reactor 102 for transporting the regenerated metal oxide catalyst 104 from the regenerator 120 to the reactor 102, so that the regenerated metal oxide catalyst 104 can continue to selectively oxidize acetylene present in the feed stream 106 within the reactor 102. The system 100B can, for example, be operated as a batch process, which can include operating the reactor 102 in the selective acetylene oxidation mode, transporting the spent metal oxide catalyst 104′ from the reactor 102 to the regenerator 120, operating the regenerator 120 in the catalyst regeneration mode to regenerate the metal oxide catalyst 104, transporting the regenerated metal oxide catalyst 104 from the regenerator 120 to the reactor 102, and then repeating the process.

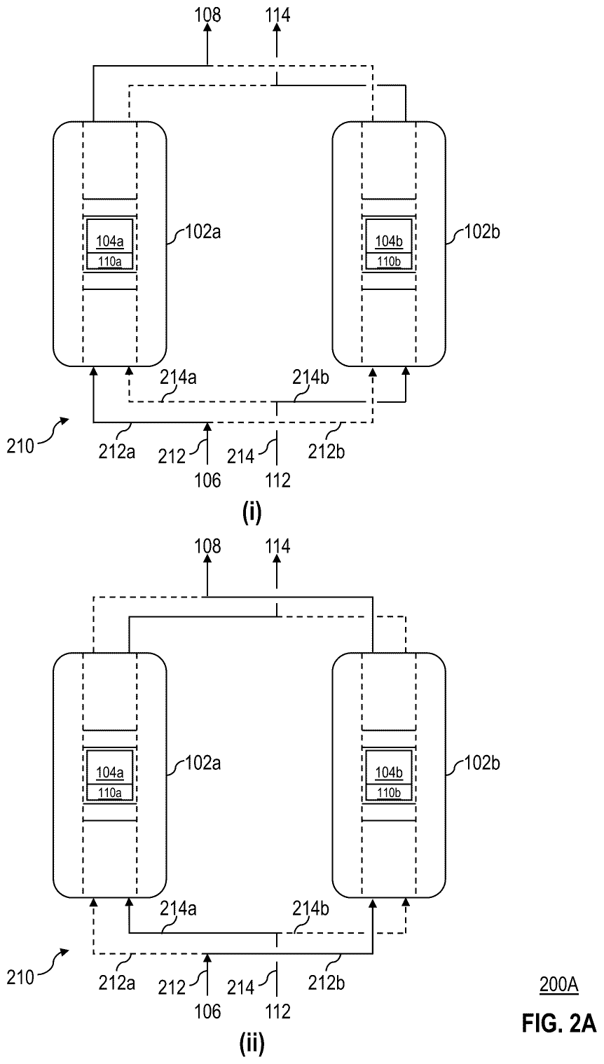

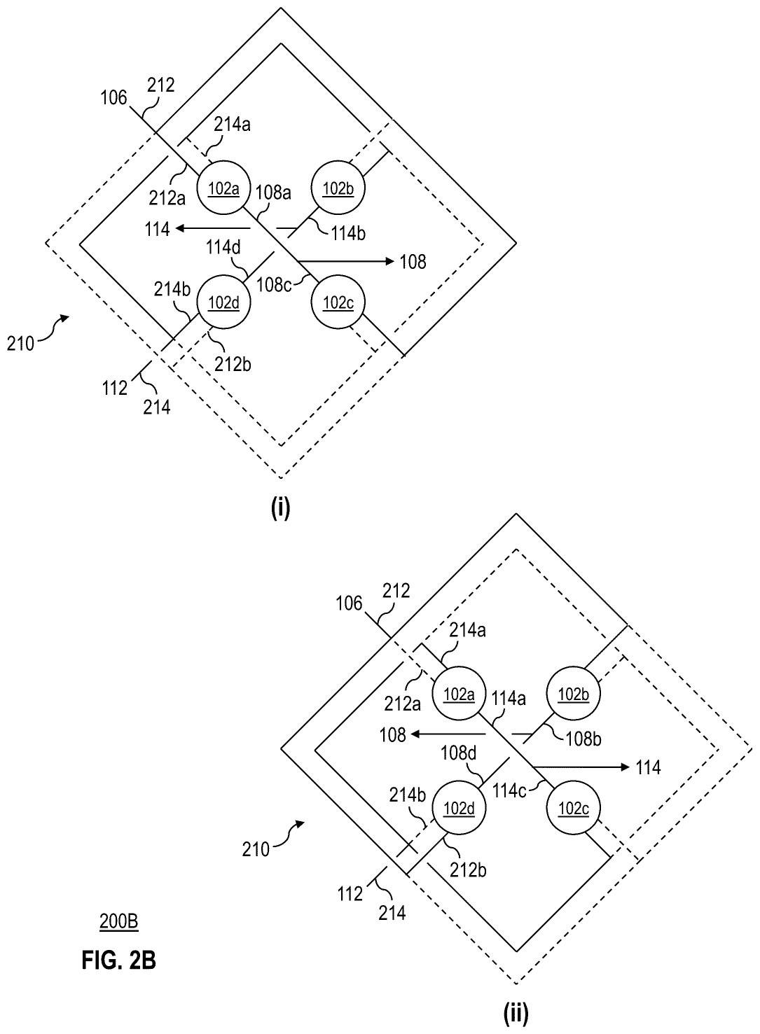

FIG. 2A depicts a schematic diagram of an example system 200A for selective oxidation of acetylene in gas mixtures. The system 200A includes two reactors 102a and 102b. Both reactors 102a and 102b can be substantially similar to each other, and both reactors 102a and 102b can be substantially similar to the reactor 102 shown in FIG. 1A. A first metal oxide catalyst is disposed within the first reactor 102a. A second metal oxide catalyst is disposed within the second reactor 102b. Both metal oxide catalysts can be substantially similar to each other, and both metal oxide catalysts can be substantially similar to the metal oxide catalyst 104 shown in FIG. 1A. In some implementations, as shown in FIG. 2A, the first metal oxide catalyst is disposed on a first support, and the second metal oxide catalyst is disposed on a second support. Both supports can be substantially similar to each other, and both supports can be substantially similar to the support 110 shown in FIG. 1A. The system 200A can include a flow control system 210 for controlling the flow of fluids through the system 200A. The flow control system 210 can include a feed inlet flowline 212 that splits (212a, 212b) and connects separately to the first reactor 102a and the second reactor 102b. For example, split 212a of the feed inlet flowline 212 connects to the first reactor 102a, and split 212b of the feed inlet flowline 212 connects to the second reactor 102b. The flow control system 210 can include an oxygen inlet flowline 214 that splits (214a, 214b) and connects separately to the first reactor 102a and the second reactor 102b. For example, split 214a of the oxygen inlet flowline 214 connects to the first reactor 102a, and split 214b of the oxygen inlet flowline 214 connects to the second reactor 102b.

The system 200A can be configured to operate in a first mode (i) in which the first reactor 102a operates in a selective acetylene oxidation mode while the second reactor 102b operates in a catalyst regeneration mode. In the first mode (i), the feed stream 106 can be flowed into the first reactor 102a via split 212a of the feed inlet flowline 212. In the first mode (i), split 212b of the feed inlet flowline 212 can be blocked to prevent flow of the feed stream 106 into the second reactor 102b. As the feed stream 106 comes into contact with the first metal oxide catalyst within the first reactor 102a, the acetylene present in the feed stream 106 is selectively oxidized, and as a result, carbon monoxide, carbon dioxide, or both are produced within the first reactor 102a. The first reactor 102a discharges the product stream 108, which includes the carbon monoxide and/or the carbon dioxide that was produced within the first reactor 102a. The product stream 108 can also include a remaining portion of the feed stream 106 that did not react within the first reactor 102a. In the first mode (i), the oxygen replenishing stream 112 can be flowed into the second reactor 102b via split 214b of the oxygen inlet flowline 214. In the first mode (i), split 214a of the oxygen inlet flowline 214 can be blocked to prevent flow of the oxygen replenishing stream 112 into the first reactor 102a. As the oxygen replenishing stream 112 comes into contact with the second metal oxide catalyst within the second reactor 102b, the oxygen present in the oxygen replenishing stream 112 replenishes the oxygen content in the second metal oxide catalyst and re-establishes the metal-oxygen bonds in the second metal oxide catalyst, thereby regenerating the second metal oxide catalyst. The second reactor 102b discharges an exhaust stream 114, which includes a remaining portion of the oxygen replenishing stream 112. The exhaust stream 114 exiting the second reactor 102b has a reduced oxygen content and/or oxygen flow rate in comparison to the oxygen replenishing stream 112 entering the second reactor 102b.

Once the second metal oxide catalyst is regenerated, the system 200A can switch in operation to a second mode (ii). In the second mode (ii), the first reactor 102a operates in the catalyst regeneration mode while the second reactor 102b operates in the selective acetylene oxidation mode. In the second mode (ii), the feed stream 106 can be flowed into the second reactor 102b via split 212b of the feed inlet flowline 212. In the second mode, split 212a of the feed inlet flowline 212 can be blocked to prevent flow of the feed stream 106 into the first reactor 102a. As the feed stream 106 comes into contact with the second metal oxide catalyst within the second reactor 102b, the acetylene present in the feed stream 106 is selectively oxidized, and as a result, carbon monoxide, carbon dioxide, or both are produced within the second reactor 102b. The second reactor 102b discharges the product stream 108, which includes the carbon monoxide and/or the carbon dioxide that was produced within the second reactor 102b. The product stream 108 can also include a remaining portion of the feed stream 106 that did not react within the second reactor 102b. In the second mode (ii), the oxygen replenishing stream 112 can be flowed into the first reactor 102a via split 214a of the oxygen inlet flowline 214. In the second mode (ii), split 214b of the oxygen inlet flowline 214 can be blocked to prevent flow of the oxygen replenishing stream 112 into the second reactor 102b. As the oxygen replenishing stream 112 comes into contact with the first metal oxide catalyst within the first reactor 102b, the oxygen present in the oxygen replenishing stream 112 replenishes the oxygen content in the first metal oxide catalyst and re-establishes the metal-oxygen bonds in the first metal oxide catalyst, thereby regenerating the first metal oxide catalyst. The first reactor 102a discharges the exhaust stream 114, which includes a remaining portion of the oxygen replenishing stream 112. The exhaust stream 114 exiting the first reactor 102a has a reduced oxygen content and/or oxygen flow rate in comparison to the oxygen replenishing stream 112 entering the first reactor 102a. The system 200A can switch between the first mode (i) and the second mode (ii), such that the system 200A is capable of operating in a continuous process (in contrast to the batch processes described in relation to systems 100A and 100B of FIGS. 1A and 1B, respectively).

FIG. 2B depicts a schematic diagram of an example system 200B for selective oxidation of acetylene in gas mixtures. The system 200B includes four reactors 102a, 102b, 102c, and 102d. Reactors 102a, 102b, 102c, and 102d can be substantially similar to each other, and reactors 102a, 102b, 102c, and 102d can be substantially similar to the reactor 102 shown in FIG. 1A. A first metal oxide catalyst is disposed within the first reactor 102a. A second metal oxide catalyst is disposed within the second reactor 102b. A third metal oxide catalyst is disposed within the third reactor 102c. A fourth metal oxide catalyst can be disposed within the fourth reactor 102d. The metal oxide catalysts can be substantially similar to each other, and the metal oxide catalysts can be substantially similar to the metal oxide catalyst 104 shown in FIG. 1A. In some implementations, as shown in FIG. 2B, the first metal oxide catalyst is disposed on a first support, the second metal oxide catalyst is disposed on a second support, the third metal oxide catalyst is disposed on a third support, and the fourth metal oxide catalyst is disposed on a fourth support. The supports can be substantially similar to each other, and the supports can be substantially similar to the support 110 shown in FIG. 1A. The system 200B can include the flow control system 210 for controlling the flow of fluids through the system 200B. The flow control system 210 can include the feed inlet flowline 212 that splits (212a, 212b) and connects separately to a first pair of the reactors (102a, 102c) and a second pair of reactors (102b, 102d). For example, split 212a of the feed inlet flowline 212 connects to the first reactor 102a and the third reactor 102c, and split 212b of the feed inlet flowline 212 connects to the second reactor 102b and the fourth reactor 102d. The flow control system 210 can include the oxygen inlet flowline 214 that splits (214a, 214b) and connects separately to a first pair of the reactors (102a, 102c) and a second pair of reactors (102b, 102d). For example, split 214a of the oxygen inlet flowline 214 connects to the first reactor 102a and the third reactor 102c, and split 214b of the oxygen inlet flowline 214 connects to the second reactor 102b and the fourth reactor 102d.

The system 200B can be configured to operate in a first mode (i) in which the first reactor 102a and the third reactor 102c operate in a selective acetylene oxidation mode while the second reactor 102b and the fourth reactor 102d operate in a catalyst regeneration mode. In the first mode (i), the feed stream 106 can be flowed into the first reactor 102a and the third reactor 102c via split 212a of the feed inlet flowline 212. In the first mode (i), split 212b of the feed inlet flowline 212 can be blocked to prevent flow of the feed stream 106 into the second reactor 102b and the fourth reactor 102d. As the feed stream 106 comes into contact with the first metal oxide catalyst within the first reactor 102a and the third metal oxide catalyst within the third reactor 102c, the acetylene present in the feed stream 106 is selectively oxidized, and as a result, carbon monoxide, carbon dioxide, or both are produced within the first reactor 102a and the third reactor 102c. The first reactor 102a and the third reactor 102c discharge product streams 108a and 108c, respectively. The product stream 108a includes the carbon monoxide and/or the carbon dioxide that was produced within the first reactor 102a and can also include a remaining portion of the feed stream 106 that did not react within the first reactor 102a. The product stream 108c includes the carbon monoxide and/or the carbon dioxide that was produced within the third reactor 102c and can also include a remaining portion of the feed stream 106 that did not react within the third reactor 102c. The product streams 108a and 108c can combine to form the product stream 108. In the first mode (i), the oxygen replenishing stream 112 can be flowed into the second reactor 102b and the fourth reactor 102d via split 214b of the oxygen inlet flowline 214. In the first mode (i), split 214a of the oxygen inlet flowline 214 can be blocked to prevent flow of the oxygen replenishing stream 112 into the first reactor 102a and the third reactor 102c. As the oxygen replenishing stream 112 comes into contact with the second metal oxide catalyst within the second reactor 102b and the fourth metal oxide catalyst within the fourth reactor 102d, the oxygen present in the oxygen replenishing stream 112 replenishes the oxygen content in the second metal oxide catalyst and the fourth metal oxide catalyst and re-establishes the metal-oxygen bonds in the second metal oxide catalyst and the fourth metal oxide catalyst, thereby regenerating the second metal oxide catalyst and the fourth metal oxide catalyst. The second reactor 102b and the fourth reactor 102d discharge exhaust streams 114b and 114d, respectively. The exhaust stream 114b includes a remaining portion of the oxygen replenishing stream 112 exiting the second reactor 102b. The exhaust stream 114b exiting the second reactor 102b has a reduced oxygen content and/or oxygen flow rate in comparison to the oxygen replenishing stream 112 entering the second reactor 102b. The exhaust stream 114d includes a remaining portion of the oxygen replenishing stream 112 exiting the fourth reactor 102d. The exhaust stream 114d exiting the fourth reactor 102d has a reduced oxygen content and/or oxygen flow rate in comparison to the oxygen replenishing stream 112 entering the fourth reactor 102d. The exhaust streams 114b and 114d can combine to form the exhaust stream 114.

Once the second metal oxide catalyst and the fourth metal oxide catalyst have been regenerated, the system 200B can switch in operation to a second mode (ii). In the second mode (ii), the first reactor 102a and the third reactor 102c operate in the catalyst regeneration mode while the second reactor 102b and the fourth reactor 102d operate in the selective acetylene oxidation mode. In the second mode (ii), the feed stream 106 can be flowed into the second reactor 102b and the fourth reactor 102d via split 212b of the feed inlet flowline 212. In the second mode, split 212a of the feed inlet flowline 212 can be blocked to prevent flow of the feed stream 106 into the first reactor 102a and the third reactor 102c. As the feed stream 106 comes into contact with the second metal oxide catalyst within the second reactor 102b and the fourth metal oxide catalyst, the acetylene present in the feed stream 106 is selectively oxidized, and as a result, carbon monoxide, carbon dioxide, or both are produced within the second reactor 102b and the fourth reactor 102d. The second reactor 102b and the fourth reactor 102d discharge product streams 108b and 108d, respectively. The product stream 108b includes the carbon monoxide and/or the carbon dioxide that was produced within the second reactor 102b and can also include a remaining portion of the feed stream 106 that did not react within the second reactor 102b. The product stream 108d includes the carbon monoxide and/or the carbon dioxide that was produced within the fourth reactor 102d and can also include a remaining portion of the feed stream 106 that did not react within the fourth reactor 102d. The product streams 108b and 108d can combine to form the product stream 108. In the second mode (ii), the oxygen replenishing stream 112 can be flowed into the first reactor 102a and the third reactor 102c via split 214a of the oxygen inlet flowline 214. In the second mode (ii), split 214b of the oxygen inlet flowline 214 can be blocked to prevent flow of the oxygen replenishing stream 112 into the second reactor 102b and the fourth reactor 102d. As the oxygen replenishing stream 112 comes into contact with the first metal oxide catalyst within the first reactor 102b and the third metal oxide catalyst within the third reactor 102c, the oxygen present in the oxygen replenishing stream 112 replenishes the oxygen content in the first metal oxide catalyst and the third metal oxide catalyst and re-establishes the metal-oxygen bonds in the first metal oxide catalyst and the third metal oxide catalyst, thereby regenerating the first metal oxide catalyst and the third metal oxide catalyst. The first reactor 102a and the third reactor 102c discharge exhaust streams 114a and 114c, respectively. The exhaust stream 114a includes a remaining portion of the oxygen replenishing stream 112 exiting the first reactor 102a. The exhaust stream 114a exiting the first reactor 102a has a reduced oxygen content and/or oxygen flow rate in comparison to the oxygen replenishing stream 112 entering the first reactor 102a. The exhaust stream 114c includes a remaining portion of the oxygen replenishing stream 112 exiting the third reactor 102c. The exhaust stream 114c exiting the third reactor 102c has a reduced oxygen content and/or oxygen flow rate in comparison to the oxygen replenishing stream 112 entering the third reactor 102c. The exhaust stream 114a and 114c can combine to form the exhaust stream 114. The system 200B can switch between the first mode (i) and the second mode (ii), such that the system 200B is capable of operating in a continuous process (in contrast to the batch processes described in relation to systems 100A and 100B of FIGS. 1A and 1B, respectively).

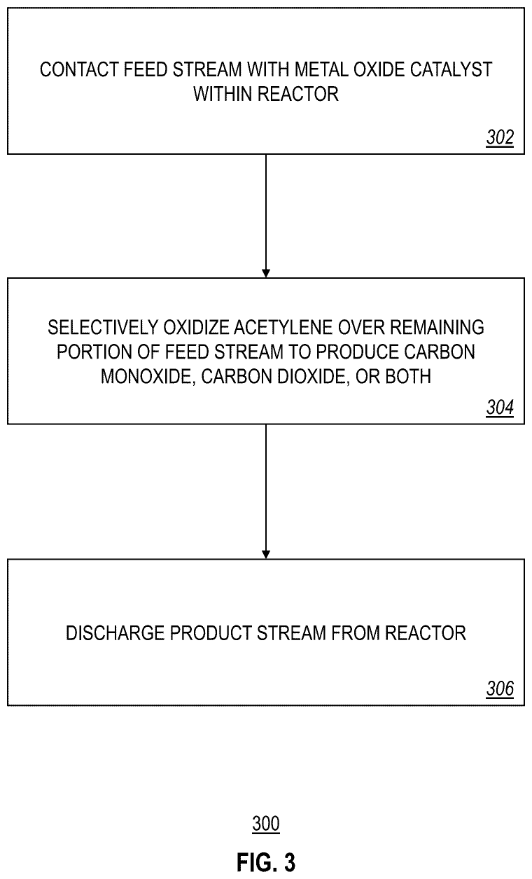

FIG. 3 is a flow chart of an example method 300 for selective oxidation of acetylene in gas mixtures. Any of the systems 100A, 100B, 200A, or 200B can, for example, implement the method 300. At block 302, a feed stream (such as the feed stream 106) is contacted with a metal oxide catalyst (such as the metal oxide catalyst 104) within a reactor (such as the reactor 102). As described previously, the feed stream 106 includes a mixture of gases that includes acetylene. In response to contacting the feed stream 106 with the metal oxide catalyst 104 at block 302, the acetylene is selectively oxidized to produce at least one of carbon monoxide or carbon dioxide at block 304. At block 306, a product stream (such as the product stream 108) is discharged from the reactor 102. The product stream 108 includes the carbon monoxide and/or carbon dioxide that was produced at block 304.

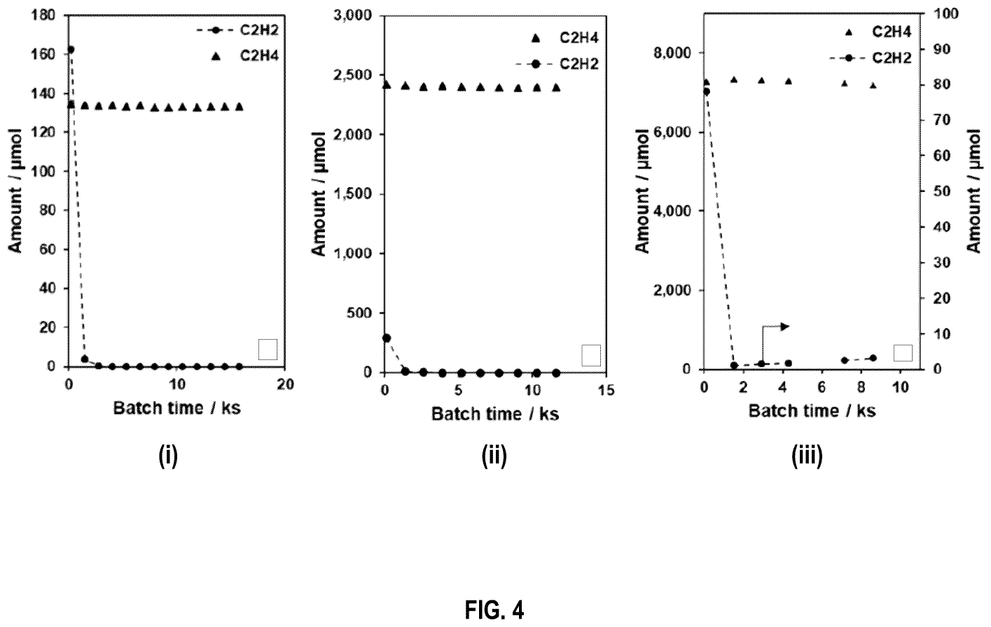

FIG. 4 shows multiple graphs (i), (ii), and (iii) showing experimental data for selective oxidation of acetylene in gas mixtures. Graph (i) shows the quantity (y-axis, in micromoles) of acetylene (C₂H₂) and ethylene (C₂H₄) over time (x-axis, in kiloseconds). The feed stream entering the reactor for the experiment depicted in graph (i) had about a 1:1 molar ratio of acetylene to ethylene. The initial partial pressure of acetylene in the feed stream was 1.0 kPa, the initial partial pressure of ethylene in the feed stream was 0.8 kPa, and the balance of the feed stream was argon. The batch reactor operating temperature for the experiment depicted in graph (i) was 773 K, and the batch reactor included 399.7 milligrams (mg) of the metal oxide catalyst (in this case, bismuth oxide). As can be seen in graph (i), the acetylene in the feed stream was selectively oxidized over ethylene. The ethylene content in the feed stream remained relatively stable (constant) in comparison to the acetylene content, and over 99% of the acetylene in the feed stream was oxidized within about 3,000 seconds (less than 1 hour).

Graph (ii) shows the quantity (y-axis, in micromoles) of acetylene (C₂H₂) and ethylene (C₂H₄) over time (x-axis, in kiloseconds). The feed stream entering the reactor for the experiment depicted in graph (ii) had about a 1:8 molar ratio of acetylene to ethylene. The initial partial pressure of acetylene in the feed stream was 1.7 kPa, the initial partial pressure of ethylene in the feed stream was 14.1 kPa, and the balance of the feed stream was argon. The batch reactor operating temperature for the experiment depicted in graph (ii) was 773 K, and the batch reactor included 399.7 milligrams (mg) of the metal oxide catalyst (in this case, bismuth oxide). As can be seen in graph (ii), the acetylene in the feed stream was selectively oxidized over ethylene. The ethylene content in the feed stream remained relatively stable (constant) in comparison to the acetylene content, and over 99% of the acetylene in the feed stream was oxidized within about 2,000 seconds (about half an hour).

Graph (iii) shows the quantity (y-axis, in micromoles) of acetylene (C₂H₂) and ethylene (C₂H₄) over time (x-axis, in kiloseconds). The feed stream entering the reactor for the experiment depicted in graph (ii) had about a 1:80 molar ratio of acetylene to ethylene. The initial partial pressure of acetylene in the feed stream was 0.56 kPa, the initial partial pressure of ethylene in the feed stream was 42.6 kPa, the initial partial pressure of argon in the feed stream was 28.5 kPa, and the balance of the feed stream was helium. The batch reactor operating temperature for the experiment depicted in graph (iii) was 773 K, and the batch reactor included 405.1 milligrams (mg) of the metal oxide catalyst (in this case, bismuth oxide). As can be seen in graph (iii), the acetylene in the feed stream was selectively oxidized over ethylene. The ethylene content in the feed stream remained relatively stable (constant) in comparison to the acetylene content, and over 99% of the acetylene in the feed stream was oxidized in less than 2,000 seconds (less than about half an hour).

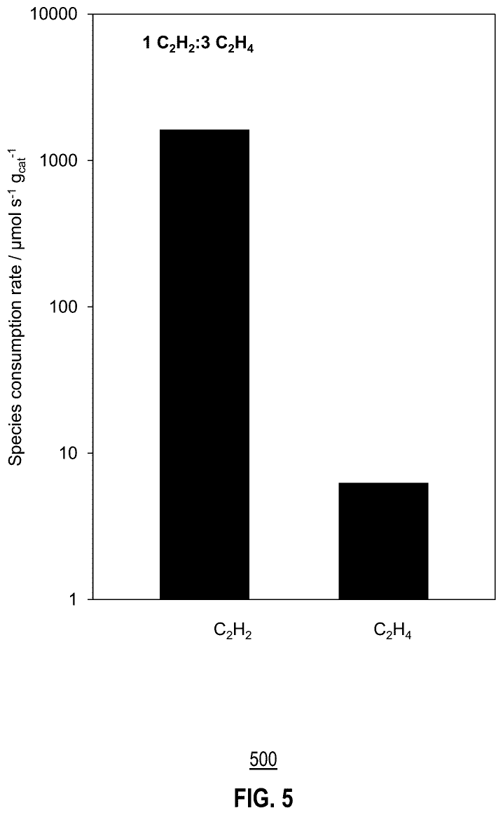

FIG. 5 is a graph 500 showing experimental data for selective oxidation of acetylene in a gas mixture including ethylene along with an oxygen co-feed. The feed stream entering the reactor had a 1:3 molar ratio of acetylene to ethylene. A co-feed of oxygen was also supplied to the reactor. The initial partial pressure of acetylene in the reactor was 0.59 kPa, the initial partial pressure of ethylene in the reactor was 1.77 kPa, the initial partial pressure of oxygen in the reactor was 1.62 kPa, the initial partial pressure of argon in the reactor was 34.61 kPa, and the balance in the reactor was helium. The reactor operating temperature for the experiment depicted in graph 500 was 773 K, and the reactor included 109.3 milligrams (mg) of the metal oxide catalyst (in this case, bismuth oxide). The flow rate of the feed stream along with the co-feed of oxygen was 66.05 cubic centimeters per minute (at standard temperature and pressure (STP, which is 0° C. and 1 atmosphere)). The amount of oxygen in the co-feed was stoichiometrically sufficient for full oxidation of acetylene into carbon monoxide, carbon dioxide, and water. The selectivity of acetylene oxidation can be defined as the fraction of oxygen consumed in oxidizing the acetylene in the feed stream versus the fraction of oxygen consumed in oxidizing the ethylene in the feed stream. The selectivity of acetylene oxidation was determined to be 99.6%. The rate of acetylene oxidation was determined to be more than 250 times the rate of ethylene oxidation for the 1:3 molar ratio of acetylene to ethylene in the feed stream with the oxygen co-feed.

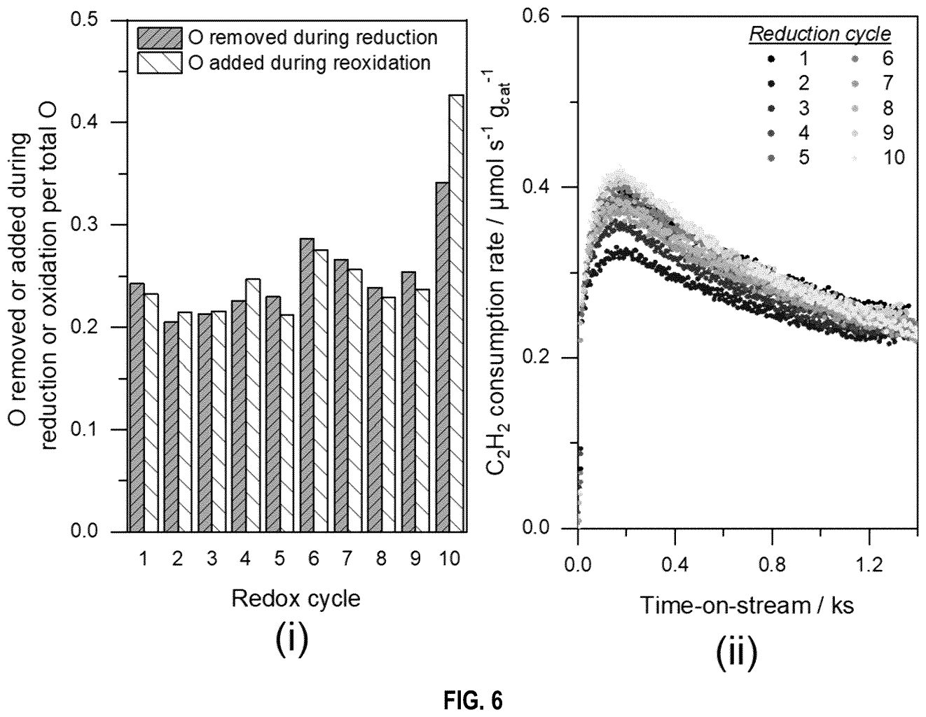

FIG. 6 shows multiple graphs (i) and (ii) showing experimental data for selective oxidation of acetylene in gas mixtures in successive reduction and oxidation cycles in a flow reactor operating at a temperature of 673 K. Graph (i) shows the quantity (y-axis, in micromoles) of oxygen atoms (O) removed in reduction cycles relative to the total oxygen content of the oxide, and oxygen atoms added in reoxidation cycles upon exposure to a gas stream containing oxygen (such as air). The feed stream entering the reactor for the experiment depicted in graph (i) had about a 1:1 molar ratio of acetylene to ethylene during reduction cycles. The partial pressure of acetylene in the feed stream entering the reactor was 1.1 kPa, the partial pressure of ethylene in the feed stream was 1.1 kPa, the balance of the feed stream had methane, helium, and argon, and the total flow rate was 1.67 cm³ s⁻¹ during reduction cycles. The feed stream entering the reactor for the experiment depicted in graph (i) had about 2.4 kPa oxygen, about 21.8 kPa helium, and balance argon with a total flow rate of 1.67 cm³ s⁻¹ during reoxidation cycles. The flow reactor for the experiment depicted in FIG. 6 included 1004.2 milligrams (mg) of the metal oxide catalyst (in this case, bismuth oxide). As can be seen in graph (i), the oxygen atoms removed during reduction cycles by acetylene combustion can be replenished by exposing the metal oxide catalyst (in this case, bismuth oxide) to streams containing oxygen (such as air) in at least 10 successive reduction and oxidation cycles. The reduction and oxidation cycles reported in graph (i) were completed in less than 3,000 seconds (less than 1 hour).

Graph (ii) shows the rate of consumption of acetylene (C₂H₂) (y-axis, in micromoles per gram catalyst per second) over time (x-axis, in kiloseconds) during successive reduction cycles which follow reoxidation steps which fully replenish the oxygen content of the catalyst (in this case, bismuth oxide). The feed stream entering the reactor for the experiment depicted in graph (ii) had about a 1:1 molar ratio of acetylene to ethylene. The partial pressure of acetylene in the feed stream entering the reactor was 1.1 kPa, the partial pressure of ethylene in the feed stream was 1.1 kPa, the balance of the feed stream had methane, helium, and argon, and the total flow rate was 1.67 cm³ s⁻¹ during reduction cycles. The flow reactor operating temperature for the experiment depicted in graph (ii) was 673 K, and the reactor included 1004.2 milligrams (mg) of the metal oxide catalyst (in this case, bismuth oxide). As can be seen in graph (ii), the acetylene consumption rate across successive reduction cycles was about the same when oxygen in the catalyst (in this case, bismuth oxide) was replenished in a reoxidation cycle following each reduction cycle. The data presented in graphs (i) and (ii) show that the oxygen removed in the reduction cycle when the catalyst is exposed to mixtures of acetylene and ethylene (in the absence of gas phase oxygen) can be fully replenished when the catalyst is exposed to oxygen containing streams (in the absence of acetylene and ethylene) during the reoxidation cycle(s). Further, the catalytic rate for acetylene consumption remains unaffected through the course of such reduction and oxidation cycles, proving that the catalyst is robust and can withstand repeated cycling.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

As used in this disclosure, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

As used in this disclosure, the term “about” or “approximately” can allow for a degree of variability in a value or range, for example, within 10%, within 5%, or within 1% of a stated value or of a stated limit of a range.

As used in this disclosure, the term “substantially” refers to a majority of, or mostly, as in at least about 50%, 60%, 70%, 80%, 90%, 95%, 96%, 97%, 98%, 99%, 99.5%, 99.9%, 99.99%, or at least about 99.999% or more.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “0.1% to about 5%” or “0.1% to 5%” should be interpreted to include about 0.1% to about 5%, as well as the individual values (for example, 1%, 2%, 3%, and 4%) and the sub-ranges (for example, 0.1% to 0.5%, 1.1% to 2.2%, 3.3% to 4.4%) within the indicated range. The statement “X to Y” has the same meaning as “about X to about Y,” unless indicated otherwise. Likewise, the statement “X, Y, or Z” has the same meaning as “about X, about Y, or about Z,” unless indicated otherwise.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described components and systems can generally be integrated together or packaged into multiple products.

Accordingly, the previously described example implementations do not define or constrain the present disclosure. Other changes, substitutions, and alterations are also possible without departing from the spirit and scope of the present disclosure.

What is claimed is:

1. A method comprising:
contacting a feed stream comprising a mixture of gases with a metal oxide catalyst disposed within a reactor, wherein the mixture of gases comprises acetylene, and the metal oxide catalyst comprises a metal oxide;
in response to contacting the feed stream with the metal oxide catalyst, selectively oxidizing the acetylene of the feed stream to produce at least one of carbon monoxide or carbon dioxide; and
discharging a product stream from the reactor, wherein the product stream comprises the at least one of the carbon monoxide or the carbon dioxide produced.

2. The method of claim 1, wherein the metal oxide comprises at least one of bismuth (Bi), indium (In), antimony (Sb), tellurium (Te), chromium (Cr), lanthanum (La), lead (Pb), tin (Sn), molybdenum (Mo), platinum (Pt), rhodium (Rh), cobalt (Co), manganese (Mn), zinc (Zn), silver (Ag), palladium (Pd), copper (Cu), hafnium (Hf), niobium (Nb), cerium (Ce), or iron (Fe).

3. The method of claim 2, wherein the metal oxide catalyst is disposed on a support comprising at least one of silicon oxide, aluminum oxide, titanium oxide, niobium oxide, or zirconium oxide.

4. The method of claim 2, wherein the metal oxide catalyst further comprises a promoter comprising at least one of lithium (Li), potassium (K), cesium (Cs), magnesium (Mg), strontium (Sr), barium (Ba), chromium (Cr), molybdenum (Mo), tungsten (W), nickel (Ni), palladium (Pd), platinum (Pt), copper (Cu), silver (Ag), gold (Au), zinc (Zn), cadmium (Cd), mercury (Hg), gallium (Ga), indium (In), thallium (Tl), tin (Sn), lead (Pb), arsenic (As), antimony (Sb), bismuth (Bi), lanthanum (La), cerium (Ce), samarium (Sm), europium (Eu), or dysprosium (Dy), and the method further comprises increasing at least one of reactivity, selectivity to acetylene oxidation, or structural stability of the metal oxide catalyst, by the promoter, in response to loss of oxygen by the metal oxide catalyst.

5. The method of claim 1, wherein the product stream discharged from the reactor has an acetylene content less than about 10 parts per million (ppm).

6. The method of claim 1, further comprising flowing an oxygen replenishing stream comprising oxygen to the reactor after discharging the product stream, wherein the oxygen of the oxygen replenishing stream increases a number of metal-oxygen bonds in the metal oxide catalyst, thereby regenerating the metal oxide catalyst.

7. The method of claim 1, further comprising flowing the oxygen replenishing stream to a second reactor within which a second metal oxide catalyst is disposed, wherein the second metal oxide catalyst comprises a second metal oxide, wherein the oxygen of the oxygen replenishing stream increases a number of metal-oxygen bonds in the second metal oxide catalyst, wherein the oxygen replenishing stream is flowed to the second reactor while the feed stream is contacted with the metal oxide catalyst within the reactor.

8. The method of claim 7, further comprising:
contacting the feed stream with the second metal oxide catalyst within the second reactor, wherein the oxygen replenishing stream is flowed to the reactor while the feed stream is contacted with the second metal oxide catalyst within the second reactor;
in response to contacting the feed stream with the second metal oxide catalyst, selectively oxidizing the acetylene of the feed stream to produce at least one of carbon monoxide or carbon dioxide; and
discharging a second product stream from the second reactor, wherein the second product stream comprises the at least one of the carbon monoxide or the carbon dioxide produced within the second reactor.

9. The method of claim 1, further comprising:
transporting the metal oxide catalyst from the reactor to a regenerator; and
flowing an oxygen replenishing stream comprising oxygen to the regenerator, wherein the oxygen of the oxygen replenishing stream increases a number of metal-oxygen bonds in the metal oxide catalyst, thereby regenerating the metal oxide catalyst.

10. A system comprising:
a reactor configured to receive a feed stream comprising a mixture of gases, wherein the mixture of gases comprises acetylene; and
a metal oxide catalyst disposed within the reactor, wherein the metal oxide catalyst comprises a metal oxide, wherein the metal oxide catalyst is configured to, in response to contact with the feed stream within the reactor, selectively oxidize the acetylene of the feed stream to produce at least one of carbon monoxide or carbon dioxide, wherein the reactor is configured to discharge a product stream comprising the at least one of the carbon monoxide or the carbon dioxide produced.

11. The system of claim 10, wherein the metal oxide comprises at least one of bismuth (Bi), indium (In), antimony (Sb), tellurium (Te), chromium (Cr), lanthanum (La), lead (Pb), tin (Sn), molybdenum (Mo), platinum (Pt), rhodium (Rh), cobalt (Co), manganese (Mn), zinc (Zn), silver (Ag), palladium (Pd), copper (Cu), hafnium (Hf), niobium (Nb), cerium (Ce), or iron (Fe).

12. The system of claim 11, wherein the metal oxide catalyst is disposed on a support comprising at least one of silicon oxide, aluminum oxide, titanium oxide, niobium oxide, or zirconium oxide.

13. The system of claim 11, wherein the metal oxide catalyst further comprises a promoter configured to increase at least one of reactivity, selectivity to acetylene oxidation, or structural stability of the metal oxide catalyst in response to loss of oxygen by the metal oxide catalyst, wherein the promoter comprises at least one of lithium (Li), potassium (K), cesium (Cs), magnesium (Mg), strontium (Sr), barium (Ba), chromium (Cr), molybdenum (Mo), tungsten (W), nickel (Ni), palladium (Pd), platinum (Pt), copper (Cu), silver (Ag), gold (Au), zinc (Zn), cadmium (Cd), mercury (Hg), gallium (Ga), indium (In), thallium (Tl), tin (Sn), lead (Pb), arsenic (As), antimony (Sb), bismuth (Bi), lanthanum (La), cerium (Ce), samarium (Sm), europium (Eu), or dysprosium (Dy).

14. The system of claim 10, wherein the product stream has an acetylene content less than about 10 parts per million (ppm).

15. The system of claim 10, wherein the reactor is configured to receive an oxygen replenishing stream comprising oxygen after discharging the product stream, wherein the oxygen of the oxygen replenishing stream increases a number of metal-oxygen bonds in the metal oxide catalyst, thereby regenerating the metal oxide catalyst.

16. The system of claim 10, further comprising:
a second reactor; and
a second metal oxide catalyst disposed within the second reactor, wherein the second metal oxide catalyst comprises a second metal oxide.

17. The system of claim 15, further comprising a flow control system comprising:
a feed inlet flowline that splits and connects separately to the reactor and the second reactor, wherein the feed inlet flowline is configured to flow the feed stream to one of the reactor or the second reactor at any given time; and
an oxygen inlet flowline that splits and connects separately to the reactor and the second reactor, wherein the oxygen inlet flowline is configured to flow the oxygen replenishing stream to a different one of the reactor or the second reactor as the feed inlet flowline.

18. The system of claim 11, further comprising a regenerator configured to receive an oxygen replenishing stream comprising oxygen, wherein the regenerator is connected to the reactor by a spent catalyst flowline configured to transport the metal oxide catalyst from the reactor to the regenerator, wherein the oxygen of the oxygen replenishing stream increases a number of metal-oxygen bonds in the metal oxide catalyst within the regenerator, thereby regenerating the metal oxide catalyst.

19. The system of claim 18, further comprising a regenerated catalyst flowline configured to transport the regenerated metal oxide catalyst from the regenerator to the reactor.

20. The system of claim 11, wherein the mixture of gases further comprises a hydrocarbon different from acetylene.
